(19) United States
(12) Patent Application Publication
(10) Pub. No.: US 2019/0178299 A1
(43) Pub. Date: Jun. 13, 2019

(54) CONSTANT VELOCITY JOINT WITH VENT SLEEVE

(71) Applicant: NEAPCO INTELLECTUAL PROPERTY HOLDINGS, LLC, Farmington Hills, MI (US)

(72) Inventors: Nick Dubiel, Fenton, MI (US); Robert J. Wehner, Livonia, MI (US); Michael Hopson, Clinton Township, MI (US); Michael Kinsella, White Lake, MI (US)

(21) Appl. No.: 16/211,452

(22) Filed: Dec. 6, 2018

Related U.S. Application Data
(60) Provisional application No. 62/595,838, filed on Dec. 7, 2017.

(51) Int. Cl. F16D 3/84

(52) U.S. Cl. CPC F16D 3/845; F16D 2003/846

(57) ABSTRACT

A constant velocity joint includes a shaft. The constant velocity joint also includes a boot member. The boot member covers a portion of the shaft. A corrosion resistant sleeve is disposed intermediate the shaft and the boot member. The sleeve includes a vent channel. The vent channel is formed only in an outer surface of the sleeve.

### CROSS REFERENCE TO RELATED APPLICATIONS

This application claims the benefit of U.S. Provisional Application No. 62/595,838, filed on Dec. 7, 2017. The entire disclosure of the above application is hereby incorporated herein by reference.

### FIELD

The present invention relates to joint assemblies and more particularly to an assembly for venting elevated pressure within the joint assemblies.

### BACKGROUND OF THE INVENTION

Joint assemblies such as constant velocity joints are common components in automotive vehicles for applications requiring a transmission of rotating motion such as constant velocity motion. Constant velocity joints (CV joints) are typically used to transmit torque from a transmission of a vehicle to final drive components at a constant velocity or speed.

Common types of CV joints include an outer joint member and an inner joint member. The outer joint member typically includes a hollow chamber which is open at one end and closed at an opposing end. The inner joint member is configured to receive a shaft of the vehicle and includes roller assemblies coupled thereto. The outer joint member co-axially receives the inner joint member. A boot is typically employed for sealing the CV joint from outside contaminants such as water, dirt, and other environmental components which can cause damage to the CV joint. Generally, the boot is coupled adjacent to an open end of the outer joint member, covers the inner joint member received in the chamber, and engages the shaft to seal the chamber.

However, during operation of the vehicle, especially during operation at high temperatures, high internal pressure can build up within the chamber of the CV joint. The high internal pressure may cause the boot to deform or expand in a manner that can be detrimental to the durability, sealing, or function of the boot, thus minimizing the effectiveness and longevity of the CV joint. Therefore, it is desired to vent the pressures contained or built up within the chamber of the CV joint to the atmosphere.

Prior art vent channels used to vent the CV joint are complex and difficult to manufacture. For example, some CV joints utilize a complex combination of axially, circumferentially, or helically oriented and continuous vent channels formed along an inside surface of the boot. An example of these complex combinations of vent channels are shown and described in U.S. Pat. No. 6,793,584, the disclosure of which is hereby incorporated herein in its entirety. These complex combinations of channels are not only difficult to manufacture but are prone to deformation as a result of thin cross-sections created by the vent channels. The thin cross-sections are typically formed at an area of the boot subject to high compression and deformation from an external retention clamp. The retention clamp is typically employed to engage the boot to the shaft of the inner joint member. The compression and deformation may cause the vent channels to become blocked.

Another prior art system used to vent CV joints relies on axial grooves on the inner surface of the boot as shown and described in U.S. Pat. No. 9,206,858, the disclosure of which is hereby incorporated herein in its entirety. The axial grooves cooperate with a circumferential groove formed on an inner boot sleeve located in contact with the inner joint member, and disposed between the boot and the shaft of the inner joint member, to form a continuous vent path. This system minimizes a complexity of the configuration of the vent paths and increases rigidity of a vent path less prone to deformation in the area of the boot adjacent the external retention clamp.

Additionally, as mentioned hereinabove, CV joint venting is commonly attained through use of vent channels defined by grooves formed on the inner surface of the boot or boot sleeve cooperating with the outer surface of the shaft. The shaft and boot sleeve are commonly formed from a steel material or a similar metal. Therefore, a surface of the vent channels contain steel (or similar material) surfaces when grooves of the boot or sleeve form a vent channel against the outer diameter of the shaft. As a result, the vent channels are prone to corrosion at the steel surfaces when water becomes trapped within the vent channels. The corrosion from the water can cause the steel surface to scale or blister. In turn, the vent channels can become blocked. An example of a boot sleeve with an inner helical groove cooperating with the shaft is shown and described in U.S. Pat. No. 4,224,808, the disclosure of which is hereby incorporated in its entirety herein. Additional disadvantages of the aforementioned boot sleeve are the relatively lengthy helical/spiral groove formed in the inner diameter of the sleeve which increases complexity of manufacturing and assembly.

A similar corrosion concern exists for CV joints having an outer pressure-activated diaphragm seal. The diaphragm seal is usually formed at an axial end of the boot and rests on the shaft or sleeve. The steel surface of the shaft or sleeve can cause the diaphragm seal to wear or corrode.

Accordingly, it would be desirable to provide a CV joint that maximizes venting efficiency of internal pressure contained therein and minimizes corrosion and deformation of components thereof.

### SUMMARY OF THE INVENTION

In accordance and attuned with the present invention, provide a CV joint that maximizes venting efficiency of internal pressure contained therein and minimizes corrosion of components thereof, has surprisingly been discovered.

According to an embodiment of the disclosure, a constant velocity joint includes a shaft. The constant velocity joint also includes a boot member. The boot member covers a portion of the shaft. A corrosion resistant sleeve is disposed intermediate the shaft and the boot member. The sleeve includes a vent channel. The vent channel is formed only in an outer surface of the shaft.

According to another embodiment of the disclosure, a constant velocity joint includes a shaft extending from an inner race of the constant velocity joint and a boot member covering a portion of the shaft. A corrosion resistant sleeve is disposed intermediate the shaft and the boot member. A vent channel is formed only in the sleeve.

According to yet another embodiment of the disclosure, a constant velocity joint is disclosed. The constant velocity joint includes a shaft extending from an inner race of the constant velocity joint and a boot member covering a portion of the shaft and the inner race. The boot member has a first end and a second end. The boot member defines a first inner region adjacent the first end thereof. A corrosion resistant sleeve is disposed intermediate the shaft and the boot member. A vent channel is formed helically in an outer surface of the sleeve. The vent channel provides fluid communication between the first inner region and a second inner region disposed adjacent the second end of the boot member or the environment.

### BRIEF DESCRIPTION OF THE DRAWINGS

The above advantages of the invention will become readily apparent to those skilled in the art from reading the following detailed description of an embodiment of the invention in the light of the accompanying drawing which is a top perspective view of a portion of a joint and shaft assembly according to an embodiment of the disclosure.

FIG. 1 illustrates a fragmentary cross-sectional front elevational view of an inner race, a shaft, a sleeve, and a boot assembly of a constant velocity joint according to an embodiment of the disclosure;

FIG. 2 illustrates a front perspective view of the sleeve of the constant velocity joint of FIG. 1; and

FIG. 3 illustrates a cross-sectional front elevational view of a sleeve of a constant velocity joint according to another embodiment of the disclosure.

### DETAILED DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

As used herein, substantially is defined as “to a considerable degree” or “proximate” or as otherwise understood by one ordinarily skilled in the art. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters. Where any conflict or ambiguity may exist between a document incorporated by reference and this detailed description, the present detailed description controls. Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, or layer.

The present technology relates to joint and shaft assemblies, such as constant velocity joints and shafts, used in vehicles. However, the present disclosure can apply to other types of joint and shaft assemblies used in vehicles or in other applications. Joint and shaft assemblies according to the disclosure are configured to facilitate a transmission of rotational forces and torque between components of a vehicle.

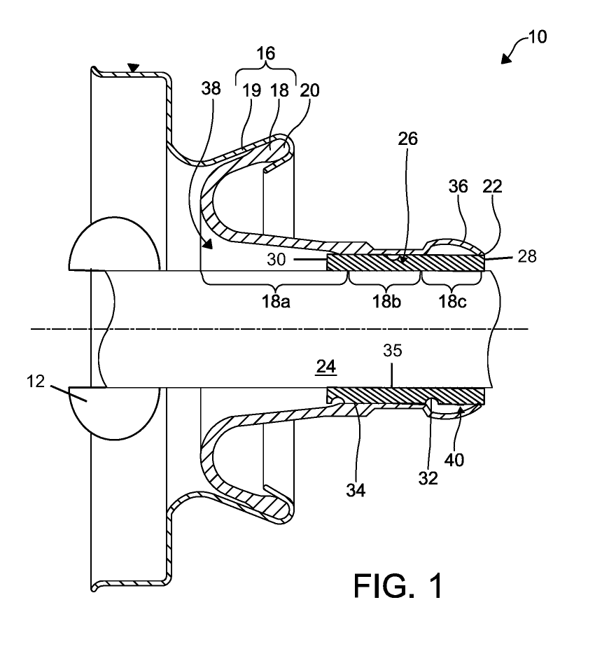

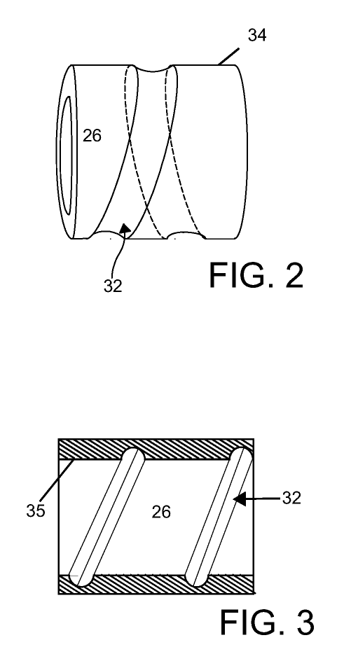

FIGS. 1-2 illustrate a constant velocity (CV) joint 10 according to the disclosure. The joint 10 can be a tri-pod type or ball-type constant velocity joint. Additionally, the joint 10 can be a plunging or fixed constant velocity joint. The joint 10 includes an inner race 12, an outer race (not shown), and a boot assembly 16. The outer race is configured to receive a shaft extending from one end thereof. The inner race 12 is coupled to a shaft 24 such as a drive shaft or propeller shaft, for example, and is received in the outer race.

A plurality of rolling elements (not shown) is disposed intermediate an outer surface of the inner race 12 and an inner wall of the outer race. The rotation of the outer race will rotate the inner race 12 at substantially the same or constant speed. As a result, a constant velocity will flow through the joint 10 between two shafts such as the shaft of the outer race and the shaft 24 of the inner race 12. The rolling elements permit the shaft 24 of the inner race 12 and the shaft of the outer race to be angled with respect to each other.

The boot assembly 16 is formed from two main components: a boot member 18 and a boot cover 19. The boot cover 19 engages an outer surface of the outer race at one end and engages the boot member 18 at an opposing end. For example, the boot cover 19 includes a channel formed along an entire periphery of the opposing end to receive a first end 20 of the boot member 18. The boot member 18 is typically formed from a urethane or other rubber material. However, it is understood, the boot member 18 can be formed from any other type of plastic, rubber, or other known pliable or flexible material, as desired. A second end 22 of the boot member 18 engages a sleeve 26 received on the shaft 24. According to another embodiment (not shown), the boot member 18 and the boot cover 19 can be integrally formed to form a unitary boot assembly 16.

The boot assembly 16 is configured to seal the joint 10 from any outside contaminants such as water, dirt, environmental particulates, and other undesired materials. The boot member 18 illustrated is typical of a “J-boot” style seal, a diaphragm seal, or bellow seal. However, the boot member 18 according to the instant disclosure is not limited to the aforementioned styles of seals. The instant disclosure can be applied to boot members 18 and boot assemblies 16 of other types such as boot assemblies having boot members with multiple convolutes and commonly formed from thermoplastic elastomers.

The boot member 18 includes a diaphragm 36 formed adjacent the second end 22 thereof. The diaphragm 36 is pressure-activated and expands to permit undesired high-temperature and/or high-pressure gases formed within the boot assembly 16 to escape from the boot assembly 16. The diaphragm 36 is also a one-way sealing diaphragm to militate against the ingress of water and/or contaminants into the joint 10 while still permitting the egress of the undesired high temperature and high pressure gases.

The boot member 18 is generally bell-shaped in cross-section including a first portion 18a angling outwardly from the sleeve 26 and the shaft 24 and extending from the boot cover 19 to a second portion 18b of the boot member 18. The second portion 18b of the boot member 18 engages the sleeve 26 to form a seal therewith. A third portion 18b includes the diaphragm 36 adjacent the second end 22 thereof which selectively engages the sleeve 26 and expands outwardly from the sleeve 26 to release gases from the boot assembly 16.

The sleeve 26 is typically formed from a corrosion resistant material. For example, the sleeve 26 can be formed from a non-metallic material such as a thermoset material, a thermoplastic material, an elastomeric material, or a polymeric material. In another example, the sleeve can be formed from a metallic material treated with anti-corrosion coatings. The sleeve 26 is disposed directly intermediate the boot member 18 and the shaft 24. The sleeve 26 extends from minimally beyond the second end 22 of the boot member 18 inwardly towards the first end 20 of the boot member 18. However, the sleeve 26 does not extend to the inner race 12, wherein the a first end 28 of the sleeve 26 extends slightly beyond the second end 22 of the boot member 18 and a second end 30 of the sleeve 26 is disposed intermediate the second end 22 of the boot member 18 and the second portion 18b of the boot member 18. The sleeve 26 may be secured and sealed to the shaft 24 through a variety of means such as an interference fit, an adhesive, a press-fit, a locking ring, or other securing or attachment means or combinations thereof.

A vent channel 32 is formed in an outer surface 34 of the sleeve 26. The vent channel 32 cooperates with the boot member 18 to form passages for venting high temperature and high pressure gases from the boot assembly 16. The passage formed by the vent channel 32 cooperating with the boot member 18 permits fluid communication between a first inner region 38 defined by the first portion 18a of the boot member 18 covering the inner race 12 and a second inner region 40 formed beneath the diaphragm 36. In the embodiment illustrated, the vent channel 32 is helical. However, in other embodiments, the vent channel 32 may include one or more helical channels, axial channels, circumferential channels, or channels having other shapes or configurations or combinations thereof.

In the embodiment illustrated in FIGS. 1-2, the vent channel 32 is formed only in the outer surface 34 of the sleeve 26, wherein grooves, vent paths, or channels are not formed in the boot member 18 or the shaft 24 to cooperate with the vent channel 32. As a result, the vent channel 32 is simple while providing efficient venting between the first inner region 38 and the second inner region 40. However, according to a first alternate embodiment, the passage formed by the vent channel 32 can be formed between the shaft 24 and the sleeve 26. For example, as shown in FIG. 3, the vent channel 32 can be formed in an inner surface 35 of the sleeve 26. However, in other embodiments (not shown), the vent channel 32 can be formed in an outer surface of the shaft 24 or a combination of both the shaft 24 and the sleeve 26. According to another embodiment, the passage formed by the vent channel 32 can be formed between the sleeve 26 and the boot member 18 such as formed within the boot member 18. According to a yet another alternate embodiment, the passage can be any combination of the vent channel 32 formed in the outer surface of the shaft 24, the inner surface 35 of the sleeve 26, the outer surface 34 of the sleeve 26, and the inner surface of the boot member 18.

The sleeve 26 may be molded separately from the shaft 24 and received thereon or may be molded in place about the shaft 26. The sleeve 26 is annular and cylindrical. However, the sleeve 26 may be semi-cylindrical or partially cylindrical having a C-shaped cross-section, wherein a gap formed between arcuate ends of the sleeve 26 forms a portion of or an addition to the vent channel 32.

In the embodiment shown in FIG. 1, the diaphragm 36 directly contacts the sleeve 26 and does not contact the shaft 24. However, in other embodiments, the boot member 18 does not include the diaphragm 36. According to the embodiment without the diaphragm 36, the second inner region 40 is not included and the passages formed by the vent channels 32 provide fluid communication between the first inner region 38 and the atmosphere.

Advantageously, the CV joint 10 according to the present disclosure militates against corrosion of metal components of the joint 10 which facilitates an extended life of the CV joint 10 and minimizes deformation of the boot member 18. As a result, maximized efficiency of the boot assembly 16 is maintained. Additionally, one continuous path is formed by the vent channel 32. In the embodiment where the vent channel 32 is formed on the inner surface of the sleeve 26, corrosion is minimized due to the relatively shorter vent channel 32 compared to grooves of prior art.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A constant velocity joint comprising:
a shaft;
a boot member covering a portion of the shaft; and
a corrosion resistant sleeve disposed intermediate the shaft and the boot member, the sleeve including a vent channel formed only in an outer surface of the sleeve.

2. The constant velocity joint of claim 2, wherein the sleeve does not contact the inner race.

3. The constant velocity joint of claim 1, wherein the vent channel is helically formed in the outer surface of the shaft.

4. The constant velocity joint of claim 1, wherein the sleeve is formed from a thermoplastic material.

5. The constant velocity joint of claim 1, wherein the sleeve is formed from a metallic material.

6. The constant velocity joint of claim 5, wherein the sleeve includes an anti-corrosion coating.

7. The constant velocity joint of claim 1, wherein the boot member engages the sleeve at an axial end thereof.

8. The constant velocity joint of claim 1, wherein the boot member includes a first portion, a second portion, and a third portion, the first portion extending outwardly from the shaft and defining a first inner region, the second portion directly engaging the sleeve and disposed intermediate the first portion and the second portion, and the third portion including a diaphragm defining a second inner region.

9. The constant velocity joint of claim 8, wherein the sleeve minimally extends from the second portion of the boot member into the first portion of the boot member.

10. The constant velocity joint of claim 8, wherein the vent channel provides fluid communication between the first inner region and the second inner region.

11. A constant velocity joint comprising:
a shaft extending from an inner race of the constant velocity joint;
a boot member covering a portion of the shaft;
a corrosion resistant sleeve disposed intermediate the shaft and the boot member; and
a vent channel formed only in the sleeve.

12. The constant velocity joint of claim 11, wherein the vent channel is formed in an outer surface of the sleeve.

13. The constant velocity joint of claim 11, wherein the vent channel is formed in an inner surface of the sleeve.

14. The constant velocity joint of claim 11, wherein the vent channel is helically formed in one of an inner surface and an outer surface of the sleeve.

15. The constant velocity joint of claim 11, wherein the sleeve does not extend to the inner race of the constant velocity joint.

16. The constant velocity joint of claim 11, wherein the boot member defines a first inner region and a second inner region, the first inner region disposed adjacent a first end of the boot member and the inner race and the second inner region disposed at a second end of the boot member, the first inner region formed between the shaft and the boot member and the second inner region formed between the sleeve and the boot member.

17. The constant velocity joint of claim 16, wherein the vent channel provides fluid communication between the first inner region and the second inner region.

18. The constant velocity joint of claim 11, wherein the sleeve is formed from a metallic material with an anti-corrosion coating.

19. The constant velocity joint of claim 11, wherein the sleeve if formed from a non-metallic material.

20. A constant velocity joint comprising:
a shaft extending from an inner race of the constant velocity joint;
a boot member covering a portion of the shaft and the inner race, the boot member having a first end and a second end, the boot member defining a first inner region adjacent the first end thereof;
a corrosion resistant sleeve disposed intermediate the shaft and the boot member; and
a vent channel formed helically in an outer surface of the sleeve, the vent channel providing fluid communication between the first inner region and a second inner region disposed adjacent the second end of the boot member or the environment.
